(19) United States
(12) Patent Application Publication
(10) Pub. No.: US 2010/0012871 A1
(43) Pub. Date: Jan. 21, 2010

(54) Remote Gas Line Shut Off Valve

(76) Inventor: William Farrell, Middletown, NJ (US)

Correspondence Address: Arthur M. Peslak, Esq .;Mandel & Peslak, LLC, Suite 5, 80 Scenic Drive, Freehold, NJ, 07728-5211, US

(21) Appl. No.: 12/456,457

(22) Filed: Jun. 17, 2009

Related U.S. Application Data
(63) Continuation-in-part of application No. 12/218,630, filed on Jul. 15, 2008.

(51) Int. Cl. F16K 31/02

(52) U.S. Cl. 251/129.03

(57) ABSTRACT

A device for actuating a pneumatically operated gas-line shut-off valve is disclosed. The device comprises a shape memory alloy wire that is actuated by the application of electrical current. When the shape memory alloy wire is actuated, it opens a spring loaded air exhaust valve that releases the pneumatic pressure holding the gas-line shut-off valve in the open position. The shape memory alloy wire can be activated with an electronic remote control device or through direct wiring thereto.

### PRIORITY CLAIM

This application is a continuation-in-part of co-pending application Ser. No. 12/218,630 filed Jul. 15, 2008.

### BACKGROUND OF THE INVENTION

The present invention is directed to the field of remote gas shut-off valves for use with natural gas service into buildings. Currently, gas service is provided from main lines into buildings. Generally, the gas line enters the building, passes through a shut-off valve, into a gas meter and eventually to a furnace, stove or other appliance in the building.

The shut-off valve is required for emergency shut-off of the gas service in case of fire or other safety issues. In addition, a remote gas shut-off valve is used by the gas company to shut the gas off remotely to stop gas service when required. One type of shut-off valve currently in use is generally a pneumatically controlled valve that is held open by air pressure inside the valve. When the air pressure is discharged from the shut-off valve, the shut-off valve closes and the gas flowing into the meter and on into the building is stopped. The available shut-off valves are actuated mechanically by a bicycle tire type valve, also known as a Schraeder valve. In order to reopen the shut-off valve, air must be pumped back into the valve.

This type of shut-off valve release mechanism suffers from defects. The primary defect is that it requires someone to locate a mechanical air-pressure release device. Generally the air-pressure release device is placed on an exterior wall of the building. After the release device is located, the person would then activate it manually to close the shut-off valve. Thus, in an emergency, critical time can be lost while attempting to locate the air-pressure release device. One object of the present invention is to provide a mechanism that can be remotely activated without the necessity of manually releasing air from the shut-off valve.

Another defect is that a small capillary tube is required to be installed between the air pressure release valve on the outside of the wall and the gas-line shut off valve. This capillary tube is often times difficult to install.

### SUMMARY OF THE INVENTION

A valve controller for controlling a pneumatically operated gas line shut-off valve that is held open by the application of pneumatic pressure comprising a Schraeder valve or other spring loaded air exhaust valve connected to a pneumatic control port on the gas-line shut-off valve for discharging the pneumatic pressure holding the shut-off valve in the open position, a control device responsive to electrical current connected to the Schraeder valve or other spring loaded air exhaust valve for activating the Schraeder valve or other spring loaded air exhaust valve and discharging the pneumatic pressure holding the shut-off valve open and thereby closing the shut-off valve; and a device for providing electric current to the control device connected to the Schraeder valve or other spring loaded air exhaust valve.

### BRIEF DESCRIPTION OF THE DRAWINGS

FIGS. 1[A and B] illustrates a pneumatic gas line shutoff valve that is currently available.

FIG. 2 illustrates [one embodiment of the present invention] a pneumatic gas line shut-off valve that is currently available.

FIG. 3 illustrates [an alternate embodiment of the present invention] a cross-sectional and schematic view of an embodiment of the present invention.

FIG. 4 illustrates a perspective view of the embodiment of FIG. 3.

FIG. 5 illustrates a partial cut-away perspective view of the embodiment of FIGS. 3 and 4.

FIG. 6 is an alternate view of the embodiment of FIG. 4.

FIG. 7 is a partial cut-away view of the embodiment of FIG. 4.

FIG. 8 is a partial cut-away view of the embodiment of FIG. 4.

FIG. 9 is a partial cut-away view of the embodiment of FIG. 4.

FIG. 10 illustrates an alternate embodiment of the present invention.

### DETAILED DESCRIPTION OF THE INVENTION

The present invention will now be described in terms of the presently preferred embodiment thereof as illustrated in the drawings. Those of ordinary skill in the art will recognize that many obvious modifications may be made thereto without departing from the scope of the present invention.

The present invention is directed to use in controlling a pneumatic gas shut-off valve. Typically, these valves are located in the gas line near the inlet side of a gas meter. If the shut-off valve is open, gas flows through the shut-off valve and into the gas meter.

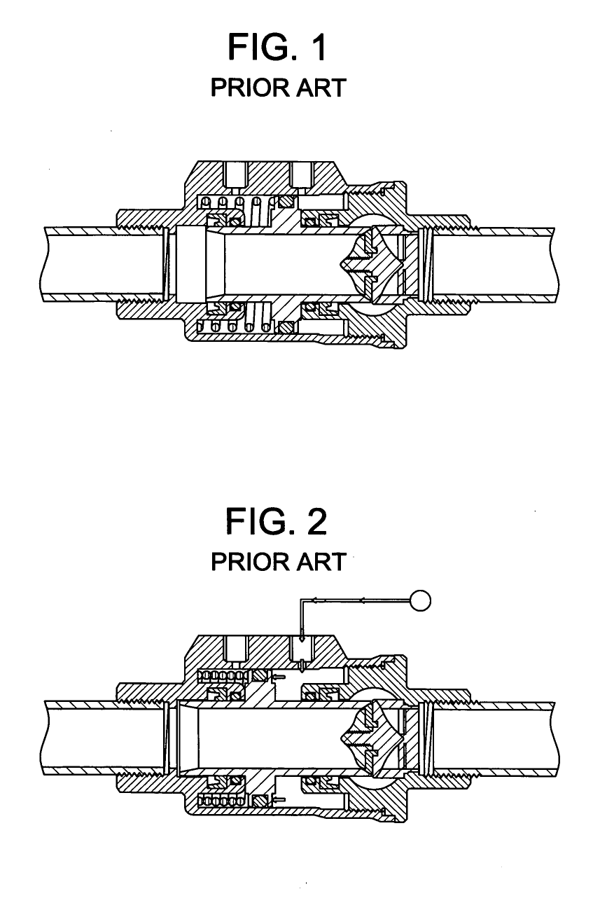

An available gas shut-off valve 10 is illustrated in FIGS. 1A and 1B. This type of valve and its operation is well known to those of ordinary skill in the art. The valve 10 is shown in its open position in FIG. 1A. The valve 10 is held in the open position by pneumatic pressure applied at the port 12. When the pneumatic pressure is discharged, the gas shut-off valve 10 will close thus shutting off the flow of gas to the gas meter. The valve 10 is shown in the closed position in FIG. 1B. The valve 10 can be reopened by pumping air into the port 12. As noted, the available gas shut-off valves 10 are opened by manually discharging the pneumatic pressure through a Schraeder valve or other similar spring loaded air exhaust valve. Typically, the device for actuating the Schraeder valve and discharging the air pressure is located on an external wall of the building near to where the gas meter is located.

The present invention is directed to the use of a shape memory alloy (SMA) wire as a means to discharge the pneumatic pressure holding the gas shut-off valve 10 in the open position. SMA wires are presently available devices that change shape when an electrical current is applied thereto. An SMA wire will return to its original shape when the electrical, current is removed. Thus, the change in the shape of the SMA wire can be used to actuate a Schraeder valve or other spring loaded air exhaust valve and discharge the pneumatic pressure holding open the gas shut-off valve 10.

One embodiment 20 of the present invention is shown in FIG. 2. In the embodiment shown in FIG. 2, the gas shut-off valve 22 is shown with a module 24 mounted on top. The module 24 comprises an electrostem valve 26. The electrostem valve 26 comprises an SMA wire 28 connected to a Schraeder valve 30. When the SMA wire 28 is actuated by means of the application of an electrical current thereto, it will open the Schraeder valve 30 to discharge the pneumatic pressure holding the gas valve 22 in its open position. This embodiment contains a radio frequency receiving unit 29. The radio frequency receiving unit 29 in this embodiment is a commercially available unit. In this embodiment, it is contemplated that the SMA wire 28 will be activated by a hand-held electronic remote control device 32 that will send a signal to the radio frequency receiving unit 29. The radio frequency receiving unit 29 will then apply an electrical current to the SMA wire 28. Thus, in this embodiment, the gas shut-off valve 22 can be closed by actuating the SMA wire 28 from a remote location by use of the remote control device 32. In addition, it is anticipated that a battery and/or capacitor will be necessary to supply power to the SMA wire 28.

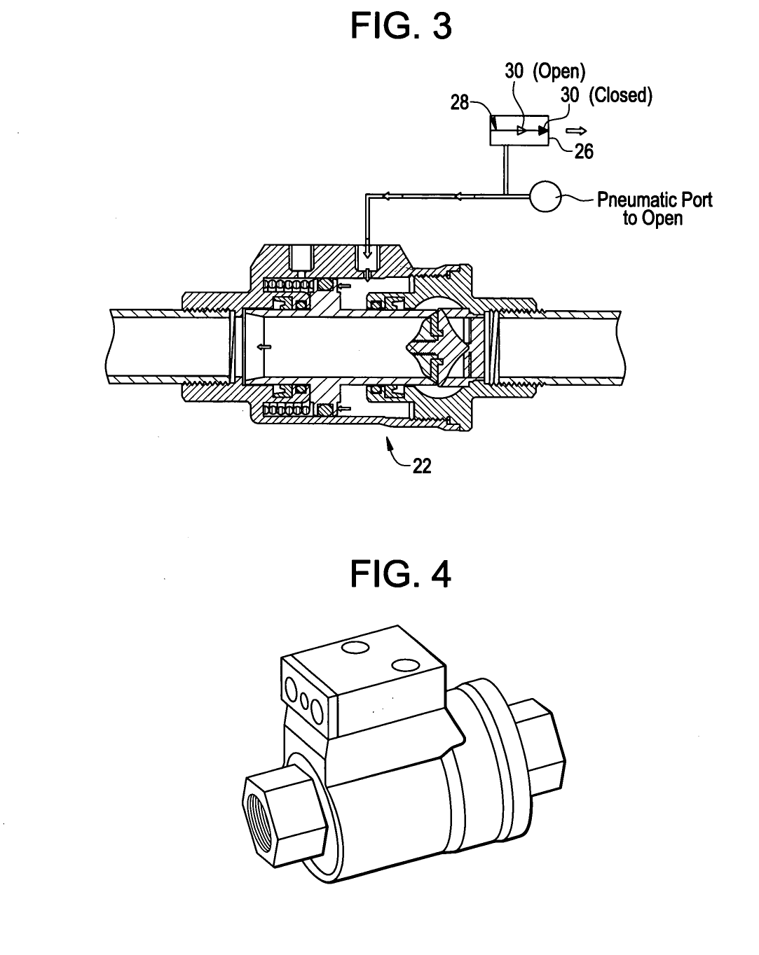

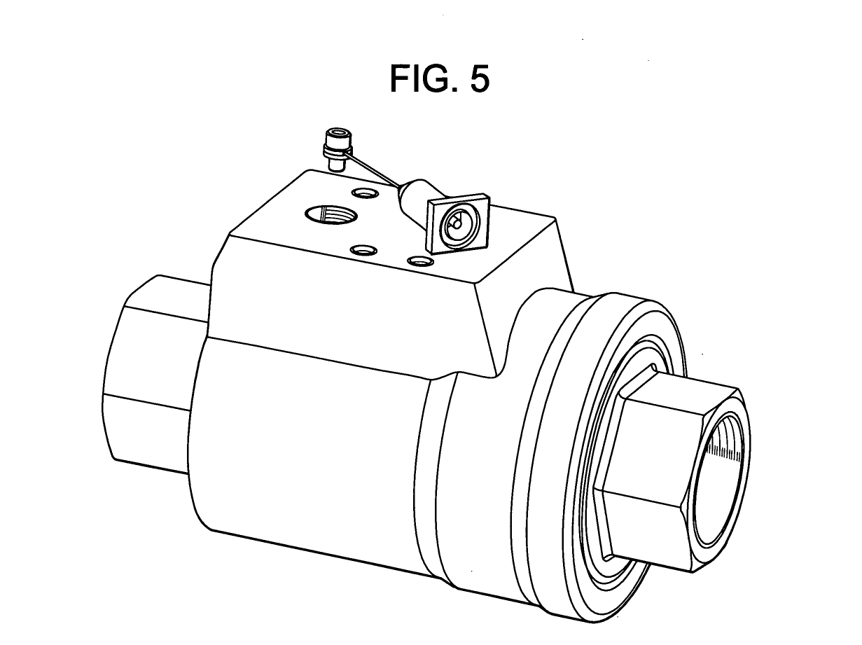

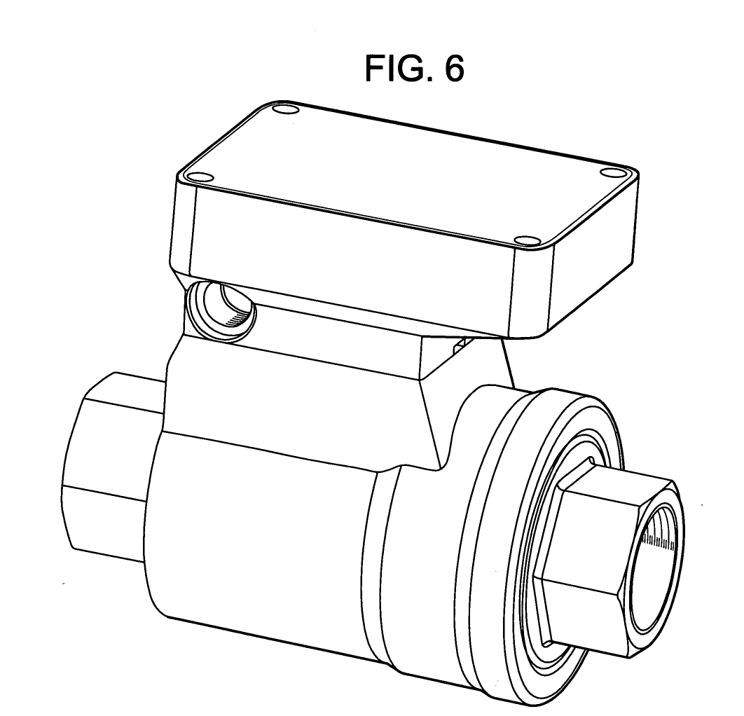

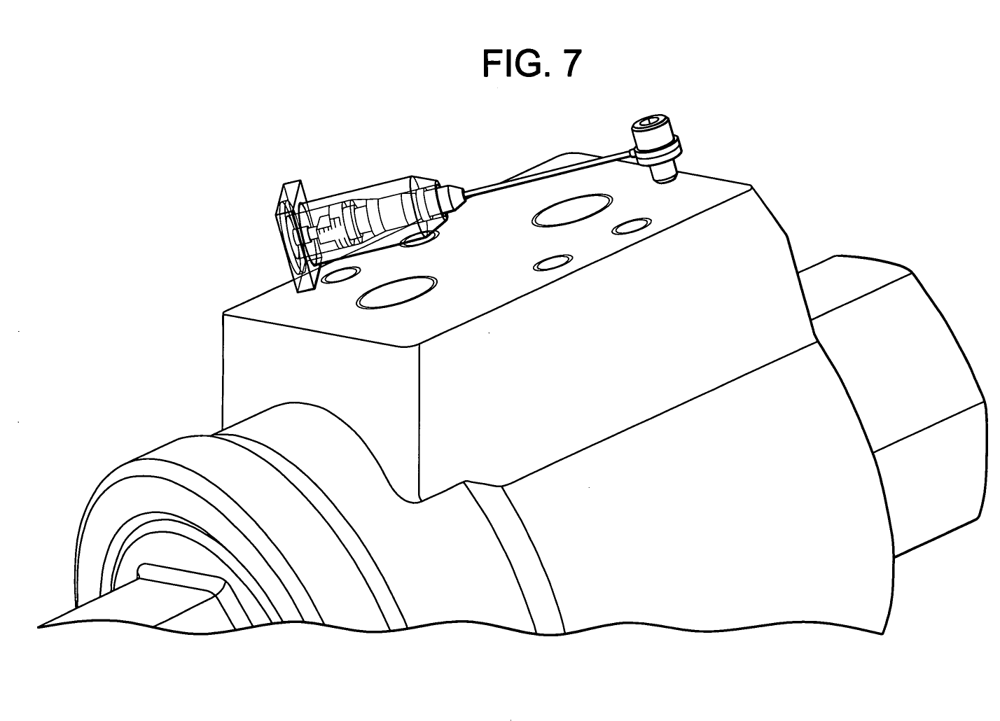

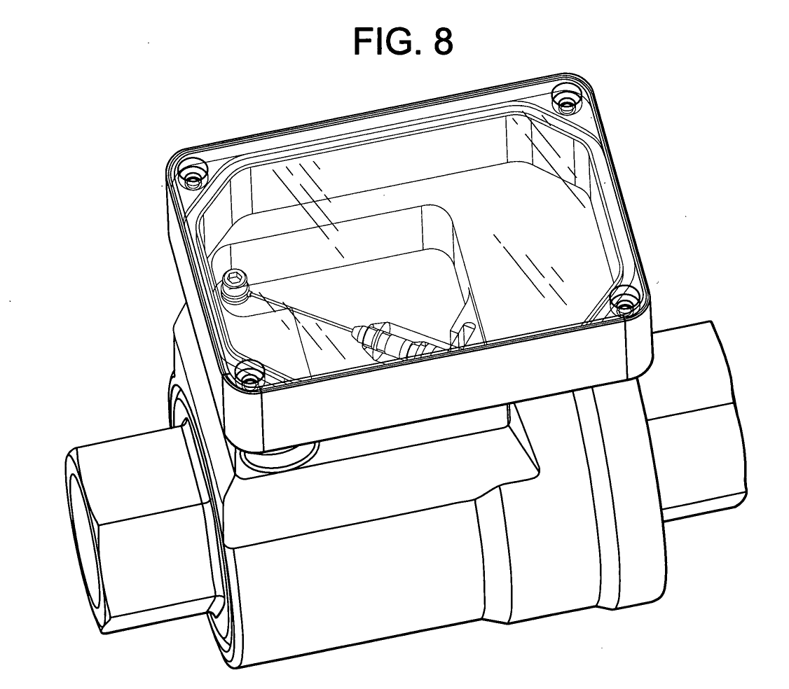

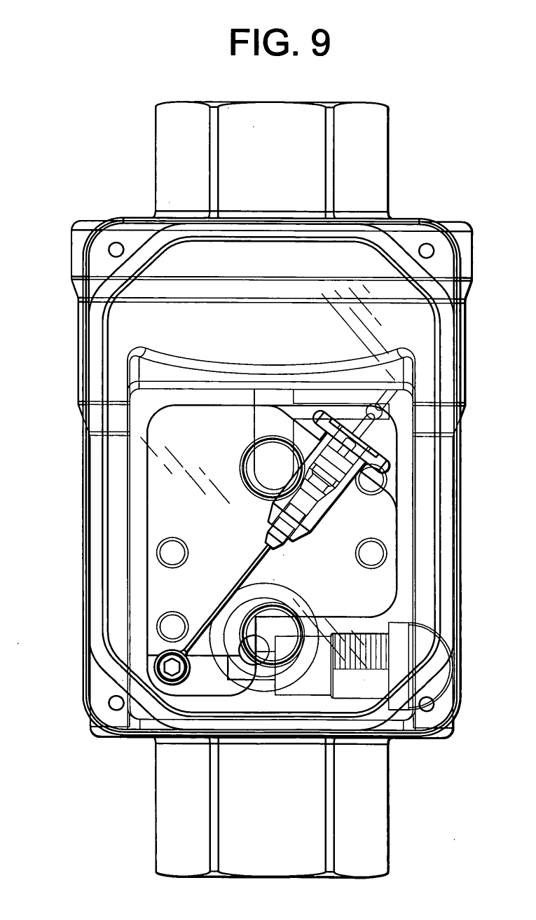

An alternate embodiment 30 of the present invention is illustrated in FIG. 3. In this embodiment, an SMA wire 32 and Schraeder valve 34 or other spring loaded air exhaust valve are integral with the gas shut-off valve 36 rather than mounted in a separate module as in the embodiment illustrated in FIG. 2. In this embodiment, the SMA wire 32 could be activated by an electronic remote control similar to the device 29.

As an alternative to the use of a hand-held electronic remote control device, the SMA wires 28 or 32 can be directly hard wired to a switch or circuit to provide the required electrical current to activate the SMA wire 28 or 32. Thus, in this alternate embodiment the radio frequency receiving unit is not utilized. Application of the current in this manner would be preferable in situations where it is controlled by an automatic reading or automatic control system.

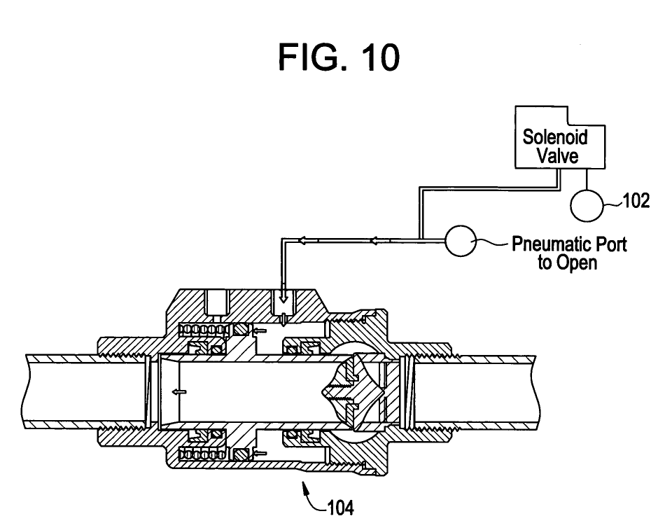

An alternate embodiment of the present invention is illustrated in FIG. 10 and will now be described in detail. In this embodiment, a solenoid valve 102 is utilized in place of an SMA wire and Schraeder valve. Solenoid valves are well known to those of ordinary skill in the art as inter alia a device to release or otherwise control fluid. Solenoid valves generally comprise two parts, a solenoid and a valve. The solenoid converts electrical current to mechanical energy to open or close the valve.

In this embodiment the solenoid valve 102 is used in conjunction with the gas shut-off valve 10 illustrated in FIG. 1. As shown in FIG. 10, the solenoid valve 102 is mounted to the gas shut-off valve 104 in a closed position. In this way, the pneumatic pressure holding the gas shut-off valve 104 is maintained and the gas shut-off valve 104 remains open. If an electrical current is applied to the solenoid valve 102, the solenoid valve 102 will open. As a result of the solenoid valve 102 opening, the pneumatic pressure holding the gas shut-off valve 104 in the open position will be discharged and the gas shut-off valve 104 will then close. At that point, the flow of gas through the gas shut-off valve 104 will be stopped. It is contemplated that the solenoid valve 104 can be activated by remote means or a hard-wired switch as described above in connection with the prior embodiments.

What is claimed is:

1. A valve controller adapted for use with a pneumatically operated gas line shut-off valve wherein the shut off valve is normally held in an open position by the application of pneumatic pressure, comprising:
a. a spring loaded air exhaust valve connected to a pneumatic control port on the gas-line shut-off valve for discharging the pneumatic pressure holding the shut-off valve in the open position;
b. a control device responsive to electrical current connected to the spring loaded air exhaust valve for actuating the spring loaded air exhaust valve and discharging the pneumatic pressure and thereby closing the shut-off valve; and
c. an electric current generating device connected to the control device for providing electrical current thereto.

2. The valve controller of claim 1 wherein the control device is a shape memory alloy wire.

3. The valve controller of claim 1 wherein the device for providing electrical current to the control device is a radio receiving frequency unit actuated by a hand-held electronic remote control device.

4. The valve controller of claim 1 wherein the device for providing electrical current to the control device is a switch wired to the control device and a power source.

5. The valve controller of claim 1 wherein the spring-loaded air exhaust valve comprises a Schraeder valve.

6. A valve controller adapted for use with a pneumatically operated gas line shut-off valve wherein the shut off valve is normally held in an open position by the application of pneumatic pressure, comprising:
a. a solenoid valve connected to a pneumatic control port on the gas-line shut-off valve for discharging the pneumatic pressure holding the shut-off valve in the open position;
b. a control device responsive to electrical current connected to the solenoid valve for actuating the solenoid valve and discharging the pneumatic pressure and thereby closing the shut-off valve; and

7. The valve controller of claim 6 wherein the control device is a radio receiving frequency unit actuated by a hand-held electronic remote control device.

8. The valve controller of claim 6 wherein the control device is a switch wired to the solenoid valve and a power source.
